(19) United States
(12) Patent Application Publication
(10) Pub. No.: US 2012/0210673 A1
(43) Pub. Date: Aug. 23, 2012

(54) Container Treatment System Having an Aseptic Wall Duct

(75) Inventor: Markus SCHOENFELDER, Regensburg (DE)

(73) Assignee: Krones AG, Neutraubling (DE)

(21) Appl. No.: 13/397,627

(22) Filed: Feb. 15, 2012

(30) Foreign Application Priority Data
Feb. 17, 2011 (DE) 10 2011 011 626.5

(51) Int. Cl. B41F 17/24; B08B 3/00

(52) U.S. Cl. 53/111 R; 134/137

(57) ABSTRACT

An apparatus for treating containers, includes a transport unit that transports the containers through a clean room and a plurality of treatment elements arranged within the clean room. The clean room is separated by a plurality of walls against an environment. The treatment elements are movable, for example, rotatable in relation to a predefined axis and movable in the direction of this axis, in order to attach closure caps onto the containers. Each of the treatment elements is arranged on a carrier that extends through a wall of the clean room, and each has a sealing unit in order to seal at least one movement of the carrier. The sealing unit includes a receptacle for receiving a liquid separating medium and a wall element movably arranged within the separating medium. At least one sealing unit has an inlet via which a cleaning medium can be supplied to the sealing unit.

### CROSS-REFERENCE TO RELATED APPLICATION

This application claims the benefit of priority of German Patent Application No. 10 2011 011 626.5, filed Feb. 17, 2011, pursuant to 35 U.S.C. 119(a)-(d), the disclosure of which is incorporated herein by reference.

### TECHNICAL FIELD

The present disclosure relates to an apparatus for treating containers. Aspects of the disclosure are described with reference to an apparatus for closing containers using closure caps. However, it is noted that the present disclosure can also be applied to other system types, such as for example to filling machines, to blow-moulding machines for moulding plastic preforms into plastic containers, and the like.

### BACKGROUND

Container treatment systems and capping machines have been known from the prior art for a long time. It is necessary here, in the case of certain applications or certain beverages to be filled in, to fill these beverages in or treat them under sterile conditions. In this process, for example in the case of a capping machine, the problem occurs that the closure cap is placed and screwed onto the container usually by means of a lift-and-turn drive. Some of the drives required for this purpose are arranged within the sterile room, which raises problems insofar as such drives can often be sources of contamination, for example, due to their bearings. It is further known to arrange the drives partially outside, such as for example a rotary drive, and to guide a corresponding lift drive through a clean room boundary via a cam follower. However, such apparatus often become relatively complex embodiments.

From DE 10 2008 034 389 A1, a wall duct as well as a container treatment machine including such wall ducts is known. In this context, a rod and/or a shaft-like function element is guided through a wall separating the sterile room, with a hydraulic seal being provided in order to seal corresponding lifting movements. Such hydraulic seals or surge tanks are known from the prior art. A particular problem area in connection with the use of such surge tanks lies in the cleaning thereof. During such a cleaning process, particular care is to be taken that these surge tanks have to separate a sterile room from the environment or from a grey room.

EP 1 821 010 A1 describes a sealing arrangement for sealing a transition between a revolving and a stationary machine element. Here, a hydraulic seal for a plurality of treatment and/or capping elements is provided.

Therefore, it may be desirable to improve the apparatus known from the prior art for treating containers with regard to keeping the respective sterile rooms sterile.

### SUMMARY

According to various aspects of the disclosure, an apparatus for treating containers, and in particular for closing containers with closure caps, may include a transport unit that transports the containers through a clean room. The clean room may be separated from the environment by a plurality of walls. The apparatus may include a plurality of treatment elements and/or capping heads which are arranged within the clean room and which are, for example, both rotatable in relation to a predefined axis and movable in the direction of this axis, in order to attach the closure caps to the containers. The term closure caps is here to be understood to mean, for example, screw caps, sealing foils, snap-in closures, crown corks, etc.

Further, each treatment element is disposed on a carrier that extends through a wall of the clean room and each treatment element has associated therewith a sealing unit in order to seal at least one movement of the carrier. In this respect, the sealing unit includes a receptacle for receiving a liquid separating medium as well as a wall element that is movable within the separating medium.

According to aspects of the disclosure, a sealing unit includes at least one inlet, via which a cleaning medium can be supplied to the sealing unit. The wall element may in some aspects be disposed on the carrier and/or movable together therewith. In some aspects, the inlet for the cleaning medium is here distinct from an inlet for the separating medium.

According to aspects of the disclosure, it is therefore proposed to associate with each treatment and/or capping head its own sealing unit. The treatment element is in general movable in two types of movement which differ from each other (rotation, lift, pivot, transverse displacement). The treatment element will be referred to hereinafter as a capping head.

In some aspects, the apparatus includes a lift drive in order to effect a movement of the capping head along the rotational axis thereof. This lift drive is here in some aspects disposed outside of the clean room. This drive may be for example a linear motor or another electric, pneumatic, or hydraulic drive; however, also a lifting cam with a cam follower could be used.

Further, in some aspects, also a rotary drive effecting a rotation of the capping head is mounted outside of the clean room. In some embodiments, the separating medium is a liquid separating medium. This separating medium completely surrounds here the carrier in the circumferential direction thereof, in some aspects however, without contacting it.

In an exemplary embodiment, the apparatus includes at least one sensor unit for sensing a filling level of the separating medium within the receptacle.

In an exemplary embodiment, the separating medium completely surrounds each carrier in the circumferential direction thereof. However, it would further also be possible for the individual receptacles for the separating medium to be connected to each other at least partially and in some aspects completely according to the principle of communicating tubes, in order to achieve in this way the same filling level in all receptacles.

It is further suggested that each of said sealing units has its own inlet for cleaning medium, so that a separate and/or common, simultaneous cleaning of all these individual sealing units is made possible. This cleaning medium may be a liquid and/or gaseous cleaning medium. The cleaning medium is in some aspects used here for cleaning the receptacle, however, in some aspects also for cleaning the wall element that is arranged to be movable. In this context, one or more nozzle units may be provided, which apply the cleaning medium onto the surfaces to be cleaned. This wall element in some aspects has a circular cross-section, with a diameter of this cross-section in some aspects being between 1 cm and 20 cm.

In an exemplary embodiment, the inlet is disposed below the receptacle. In this way, the cleaning medium is supplied from below, as a result of which a very efficient cleaning of the respective surfaces can be achieved.

In some aspects, a secure and/or complete clean room separation of the individual capping heads of a capping machine is carried out. An advantage of this approach may be that, as was mentioned above, the individual drives do not need to be mounted within the clean room, so that in this case the necessary special requirements to the respective drives or motors do not apply. Also, as a result of the approach according to the disclosure, no hermetic sealing of the clean room (only with positive pressure) is required. It is therefore proposed to carry out the respective capping head sealing by means of individual surge tanks that can be cleaned, which may afford the advantage that a lifting curve or drives no longer need to be located in the clean room either. Therefore, a hermetic clean room separation with very few components is achieved within the clean room.

The sealing of the capping head between a clean room and a grey room, i.e. an environment with a low level of hygiene, is in this way achieved via a plurality of individual sealing units and/or individual surge tanks. In the clean room itself, for example, only the capping cone is provided which attaches the closure caps onto the bottles. In some aspects, the rotary movement of the capping heads is carried out via a gear mechanism, a servomotor or another rotary drive. In some aspects, a stationary part of the sealing unit and/or the surge tank rotates together with the main axis of the capping machine, i.e. with a carrier which may also form a component of the transport unit.

In some aspects, the apparatus has a first cleaning channel, which follows on from an inlet, for carrying the cleaning medium, which first cleaning channel extends in the direction of a (rotary) axis of the carrier at least in sections. In some aspects, this cleaning channel extends in a vertical direction at least in sections. In this way, a very efficient transport of the cleaning medium within the sealing unit becomes possible.

In some aspects, said first cleaning channel is disposed radially inside or radially outside of the receptacle. In an exemplary embodiment, also a second cleaning channel is provided, which may have an annular cross section. In some aspects, the two cleaning channels are concentrical with each other, with for example the first cleaning channel being located within the second cleaning channel. In some aspects, the receptacle is located between the first cleaning channel and the second cleaning channel.

Thus, it may be desirable for a cleaning channel to be used for cleaning the clean room and/or the clean room areas and for the second cleaning channel to be used for cleaning the grey room areas.

In some aspects, the first cleaning channel has a substantially annular cross section. Thus, this annular cross section can be formed for example by two walls of the receptacle or the apparatus, which are concentric to each other.

In an exemplary embodiment, the apparatus has an outlet for the cleaning medium, which may be located in the clean room. This means that the cleaning medium can exit from within the clean room into the same, in order to be applied to corresponding walls of the clean room and/or to clean the same. The outlet may for example be a nozzle unit.

In some aspects, said outlet is disposed here above the receptacle or in some aspects above a filling level of the cleaning medium within the receptacle. In this way, a very efficient cleaning of the walls delimiting the clean room may be carried out.

In an exemplary embodiment, a wall of the cleaning channel is formed by a wall of the receptacle. Thus, it could for example be possible for the cleaning channel to be formed by a wall of the receptacle and a second concentric wall to be arranged inside or outside of this wall.

In an exemplary embodiment, the apparatus includes a stationary housing which completely surrounds the receptacle. In some aspects, each receptacle has associated therewith such a housing that is arranged to be stationary. This housing may here be designed as protection against splashes.

In an exemplary embodiment, the apparatus includes an outlet for the cleaning medium. In this way, the cleaning medium can be removed again from the receptacle or the apparatus. In some aspects, the inlet and the outlet are formed to be separate from each other.

In an exemplary embodiment, the apparatus includes a reservoir for filling a plurality of receptacles with the separating medium. In this way, a central filling of a plurality of receptacles with the separating medium becomes possible.

In an exemplary embodiment, a plurality of carriers for the treatment elements is arranged on a movable main carrier.

Further advantages and embodiments will become evident from the attached drawings.

### BRIEF DESCRIPTION OF THE DRAWINGS

In the figures:

FIG. 1a shows an apparatus for closing containers according to the prior art;

FIG. 1b shows an apparatus for closing containers according to various aspects of the disclosure;

FIG. 2 shows two detailed views of an apparatus according to various aspects of the disclosure;

FIG. 3 shows a further detailed view of an apparatus according to various aspects of the disclosure;

FIG. 4 shows a further detailed view of an apparatus according to various aspects of the disclosure;

FIG. 5 shows a further detailed view of an apparatus according to various aspects of the disclosure;

FIGS. 6a-6d show four views of an apparatus according to various aspects of the disclosure in different operation modes; and

FIGS. 7a-7b show two views of an apparatus with an eccentric layout according to various aspects of the disclosure.

### DETAILED DESCRIPTION

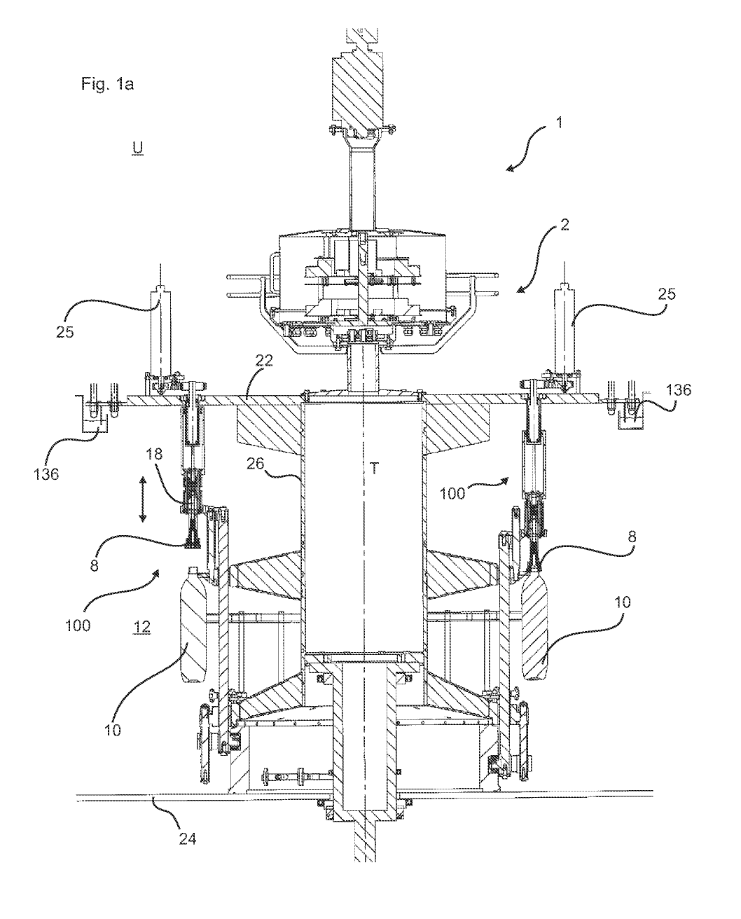

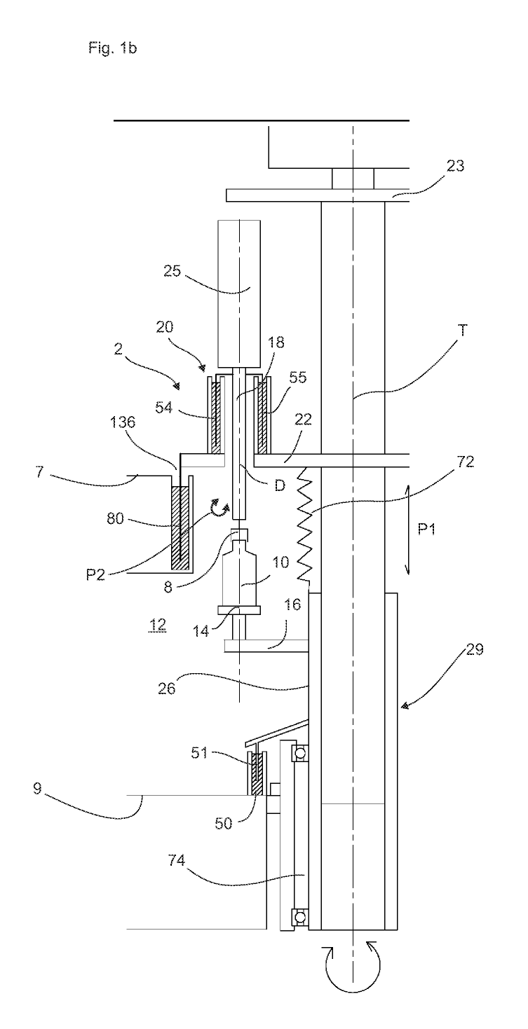

FIG. 1a shows a schematic view of a capping machine 1 according to the prior art. Here, a carrier 22 arranged to be rotatable in respect of a central axis T is provided, on which a plurality of capping elements 100 is arranged. This carrier is part of a transport unit, generally identified with 2, for transporting the containers. The containers are transported here along a circular path.

Each of these capping elements 100 has here a capping head 8 that is arranged to be movable up and down on a carrier 18 both rotationally and in the direction parallel to the axis T. By means of this capping head 8, the containers 10 can be closed with closure caps. The capping head 8 is here mounted within a clean room 12. This clean room is delimited by a plurality of walls 22, 24, 26, with the wall 26 simultaneously being the shaft of the carrier 22 or a wall of the carrier 22. A sealing unit 136 in the form of a surge tank extends around all the capping elements, which surge tank seals the entire room located inside of this sealing unit and radially outside of the wall 26 against the environment U. In this way, a very large-scale sealing unit is required.

FIG. 1b shows a schematic view of an apparatus according to the disclosure. The containers 10 are here carried by means of a container carrier 14 that is mounted on a main carrier 16. It is possible here for this main carrier 16 and the wall 22 to be arranged to be height adjustable relative to each other along the arrow P1, however, this main carrier 16 can, in some aspects, not be displaced in its height direction, especially if the container 10 is supported on the container carrier 14, as shown, by its bottom (bottom guide). Alternatively, a container carrier is possible which supports the containers 10 for example by a neck collar.

A capping machine includes a top part 23. A drive 25 for the capping head 8 effects here both a height displacement of the capping head along the arrow P1 and a rotation about the rotary axis D as illustrated by arrow P2. A sealing unit 20 is used both for sealing the rotary movement and for the lifting movement. The capping head 8 is mounted on the carrier 18. A wall element 54 movable in a revolving manner is submersed here into the separating medium 55. The sealing unit 20 is here disposed on the wall 22 and moves about the central axis T. In doing so, further sealing elements (not shown), such as for example sealing rings, may be provided between the sealing unit 20 and the wall 22. A further sealing unit 136 is used to seal the clean room 12 in respect of the common movements of all the sealing units 20. Reference numeral 7 relates to a roof of the apparatus.

Reference numeral 29 in turn identifies the wall and here also a component of the main shaft of the capping machine on which the wall 22 is mounted. This shaft is rotatably supported by means of the main bearing 74. Reference numeral 9 identifies a table top on which a further sealing unit 50 is arranged (stationary) in the form of a surge tank, and here, too, a rotatable wall element 51 is provided which slides in the separating medium of the sealing unit 50.

Provided a bottom guide in terms of a container carrier is provided, a height adjustment mechanism for the top part of the capping machine is provided for this purpose. This height adjustment is here achieved by way of extending and retracting the capping machine main shaft 29 from the wall 26 (cf. FIG. 1b). In addition, this height adjustment mechanism is sealed via the bellows 72—alternatively for example via a shaft seal ring. The height adjustment mechanism of the top part of the capping machine that is connected thereto is also made possible by a sealing device, more specifically the roof 7 of the capping unit. This means that the submersion depth of the separating element 80 in the surge tank is great enough to cover the entire height adjustment range and in order to achieve in this way a secure clean room separation. As mentioned, the rotation of the capping machine is sealed by means of a further surge tank 50 on the main bearing.

The drive of the capping elements may be carried out according to well-known principles, such as for example by means of lifting cams, linear axes, lifting-rotating servo units, stepper motors, gear mechanisms and the like.

The arrangement of the individual surge tanks above the roof surge tank (which has the separating element 80) as shown allows any excess separating liquid of the individual surge tanks to run off into the roof surge tank to prevent any separating medium from collecting on the top part of the capping machine even without the use of drain pipes in the wall 22, such as for example in the case of the sealing units 20 splashing over or the like. In this way, a complete clean room separation by means of the roof surge tank 136, the table top surge tank 50, the bellows 72 and the individual surge tanks or sealing units 20 becomes possible.

The individual sealing units 20 are here attached to the pitch circle of the machine. The number of these sealing units is determined by the pitch of the machine (i.e. the number of capping heads 8). The individual sealing units 20 are here in some aspects connected to each other by a ring line or the like in order to achieve an equal level. The sealing units may be fed via a direct feed line for liquid via a rotary distributor to one or more sealing units. The filling level of the sealing units 20 may be polled and controlled by means of one or more sensors (not shown), which may be implemented for example as floats or the like. Alternatively, it is possible to define the filling level by a respective overflow opening. The separating medium can also flow here from sealing units 20 into sealing unit 136.

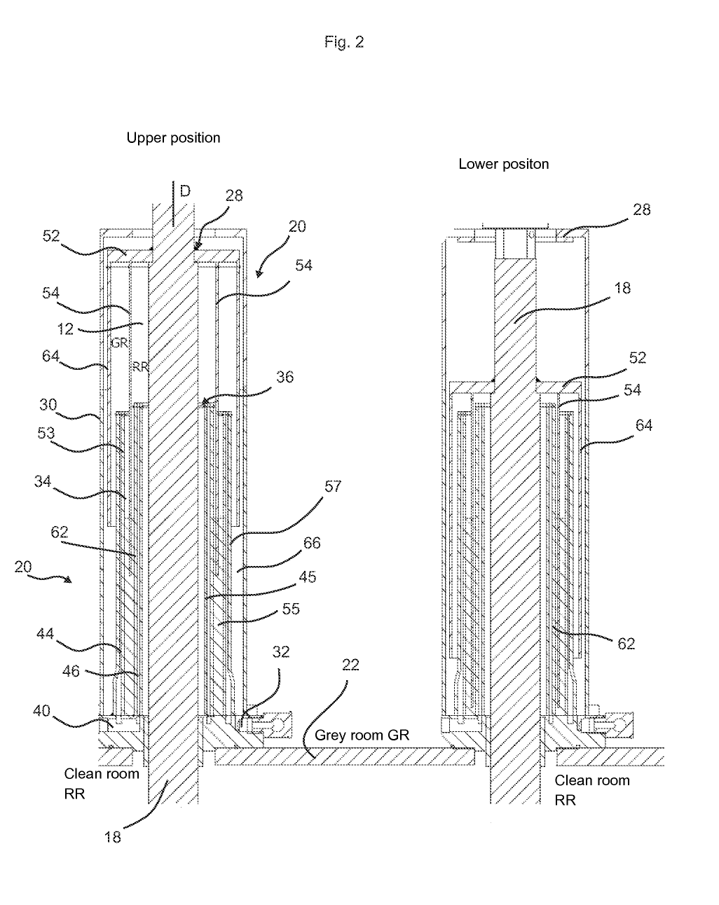

FIG. 2 shows a detailed view of an apparatus according to the disclosure. Reference numeral 18 again refers to the carrier, at the bottom end of which a capping head (not shown) is mounted. The left-hand part of FIG. 2 shows this carrier in an upper position, the right-hand part shows it in a lower position. The carrier 18 is here arranged to be rotatable about a rotary axis D and is also movable along this rotary axis D. Reference numeral 20 relates in its entirety to a sealing unit for sealing the sterile room or the clean room 12 against the environment or a grey room GR.

Reference numeral 30 refers to a housing which covers both the carrier and further elements that will be described below, in particular in order to avoid any splashes in this way. The housing is here arranged to be rotationally fixed in relation to the axis D.

Inside of the housing 30, a disc-shaped holding unit 52 is arranged on the carrier 18, which is at the same time also a component of a surge tank acting as a (hydraulic) sealing unit. On this holding unit 52, a wall element 54 is arranged which moves in a revolving manner, which therefore moves together with the carrier 18. This wall element 54 is submersed with its bottom end section into a separating liquid 55. In this way, areas which are located on the inside in relation to this wall element 54 are separated against such areas which are located outside in relation to the wall element 54. Inside of the wall element 54, the clean room RR is formed, on the outside thereof the grey room GR.

Reference numeral 34 identifies the receptacle that is used for receiving the separating medium 55. This receptacle 34 is here formed by an inner revolving wall 62 and a radially outer wall 53, and these two walls 62 and 53 are here formed to be circular about the axis D and are also concentric in relation to the circular axis D. The wall element 54 therefore extends within the receptacle 34 with the separating medium. In this way it can be seen that the receptacle has a relatively small capacity. Reference numeral 64 refers to a splashback wall which is also mounted on the holding unit 52 and therefore also rotates therewith.

Reference numeral 44 identifies a first cleaning channel, through which a cleaning medium can be supplied into the apparatus, i.e. for example into the grey room and also into the receptacle 34. This channel 44 is here formed by the wall 53 mentioned above and the wall 57 that is arranged radially outwardly relative thereto. Reference numeral 46 identifies a second (inner) cleaning channel, via which a cleaning medium can also be supplied. This second cleaning channel 46 is here formed by the wall 62 of the receptacle 34 and a wall 45 that is located radially inwards relative thereto. The cleaning medium can be supplied to the two channels 44, 46 and thus also to the sealing unit 20 via an inlet 40.

Reference numeral 32 identifies an outlet, through which the cleaning medium can here be discharged. During operation, i.e. in the production condition, the separating medium can also be supplied via this outlet. Reference numeral 36 identifies a cleaning unit such as for example nozzles, by means of which the cleaning medium can be applied during operation.

Thus, the rotating part of the surge tank rotates about its own axis and also carries out a lifting movement. This combined capping head movement, i.e. the rotation and the lift including the drive movement of the capping machine, i.e. the rotation about the capping machine axis T, is sealed by means of the separating liquid. More specifically, the clean room is here separated from a grey room.

As mentioned, the liquid level of the separating liquid 55 within the receptacle 34 is controlled by means of sensors. It is possible here for the liquid level to be generated via a central reservoir (filling) and to be drained after the production cycle. The entire surge tank itself can be cleaned via separated cleaning channels as described above.

The left-hand upper position (cf. FIG. 2) is the position in which the cleaning operation is carried out.

Above the holding unit 52, a sealing unit 28 is provided. With the carrier 18 in its upper position, this cleaning unit seals towards the top, so that in this way the entire apparatus can be cleaned or flushed within the housing 30. This sealing unit can be mounted on the holding unit 52 (see left-hand part of FIG. 2) or on the housing 30 (see right-hand part of FIG. 2) or on both.

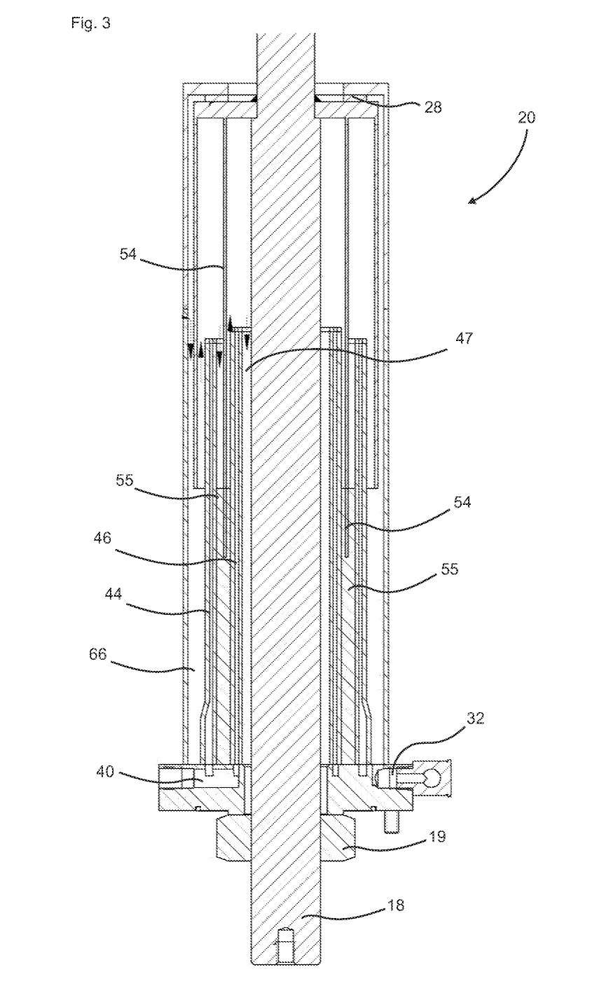

FIG. 3 shows a more detailed view of an apparatus according to the disclosure in a cleaning mode. In this cleaning mode, the carrier 18 has moved into its upmost position, so that sealing towards the top is now possible, and in this way the sealing unit 20 can be completely flushed. The cleaning medium flows, via the inlet 40, through the first (outer) cleaning channel 44 and the second (inner) cleaning channel 46 into the sealing unit and, as mentioned, the first cleaning channel 44 is located in the grey room and the second cleaning channel 46 is located within the movable wall element 54 and thus in the sterile room. Upon cleaning of the individual wall areas, the cleaning medium can be discharged again via a return 47 as well as a return 66. Since separating medium 55 is present in this illustration, the cleaning medium will in this case be gaseous.

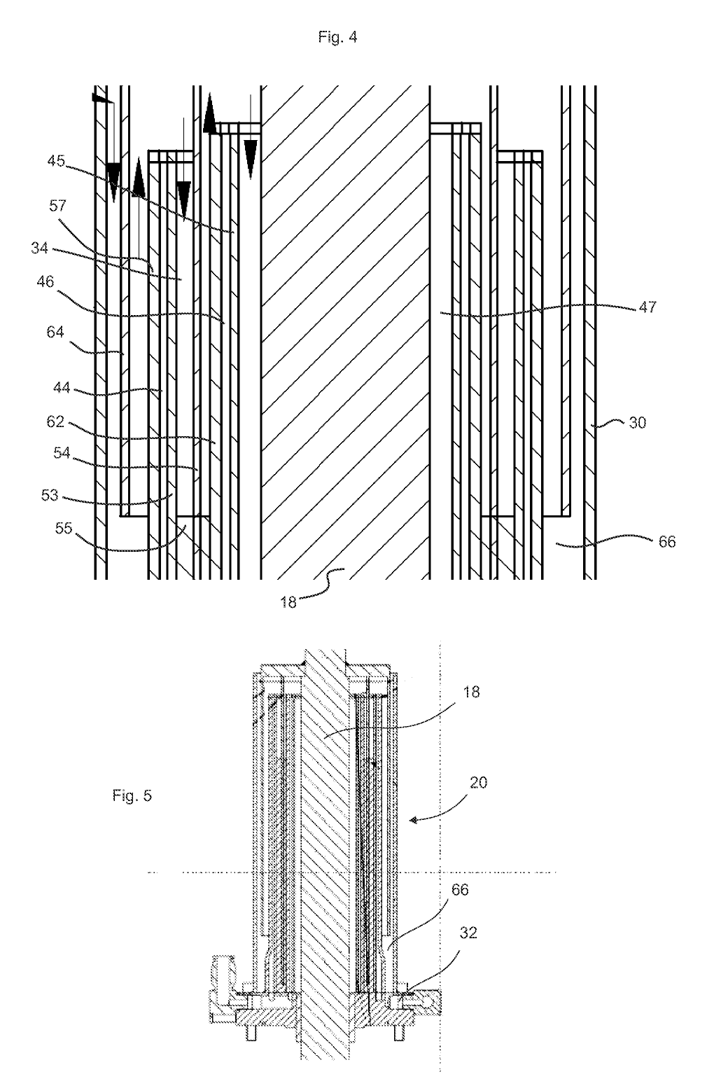

FIG. 4 shows a greatly enlarged view of an area of the apparatus according to the disclosure. What can be seen here in particular are the individual walls or wall elements 45, 62, 54, 53, 57 and 64 (from the inside towards the outside) which form the receptacle 34 and also the individual channels. The walls 45, 62, 53 and 57 are here arranged to be rotationally fixed relative to the rotary axis D. The individual walls are, as mentioned above, parallel to each other and are arranged in particular to be concentric to each other. The carrier 18 as well as the wall element 54 and the wall 64 are here arranged to be rotatable, the remaining walls are arranged to be stationary, i.e. stationary in relation to the rotary movement of the carrier 18. Altogether, the arrangement is arranged to be rotatable in relation to a central machine axis T.

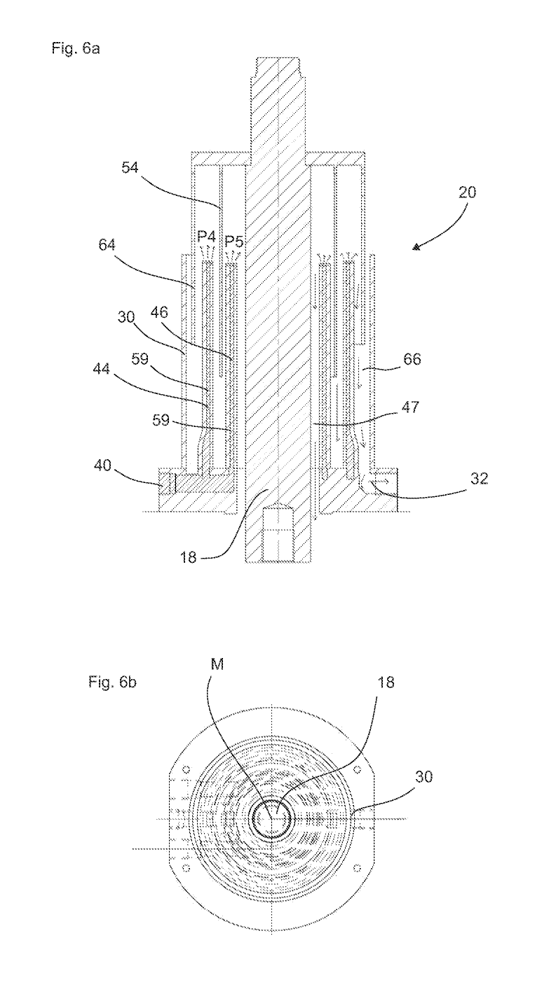

FIG. 5 shows a further view of the apparatus according to the disclosure. What can be seen here are in particular areas in which media such as for example gas can be sucked off after the cleaning operation. Gas can also be carried in channel 66.

Via an additional lift (in this example towards the top), the rotary part of the surge tank is sealed by the stationary part of the surge tank (cf. FIG. 3 with the two seals 19 and 28 at the bottom and at the top). This opens the possibility of generating, during the cleaning cycle, a continuous flow of the cleaning medium (similar to CIP cleaning on a container filling machine). This system could be used to clean the surge tank in a simple manner and the more complex installed cleaning channels can be omitted from the first-mentioned example (cf. FIG. 2). This measure thus simplifies the overall system even further.

The present disclosure therefore describes both a lower and an upper clean room separation and in addition a capping head sealing via individual, cleanable surge tanks, which may bring the advantage that a lifting cam or drive gears are no longer arranged in the clean room 12 either.

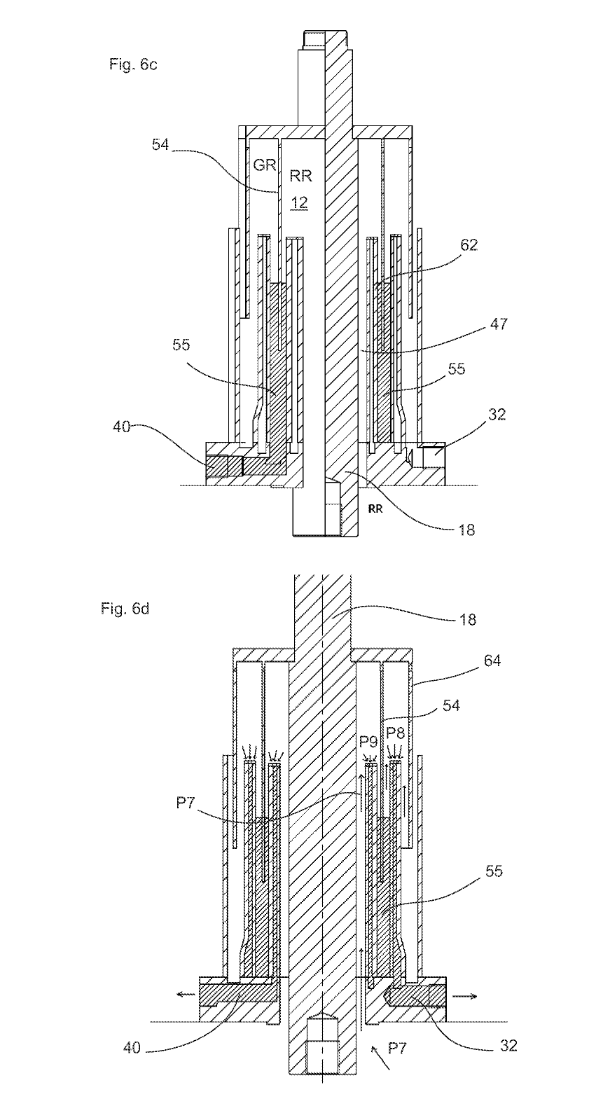

FIG. 6a shows a sealing unit according to the disclosure in a cleaning or disinfecting operation. Here, a cleaning or disinfecting medium 59 is introduced into the sealing unit 20 via an inlet 40 and two channels and exits towards the top as illustrated by arrows P4 and P5. In this way, this gaseous cleaning or disinfecting medium can flow into the entire sealing unit. The cleaning or disinfecting medium 59 can be removed again from the apparatus via the returns 66 and 47.

FIG. 6b shows a corresponding top view of the apparatus shown in FIG. 6a. It can be seen here that the individual channels and walls are respectively rotationally symmetrical in relation to the centre point M.

FIG. 6c shows the apparatus from FIG. 6a during working operation. Again, the separating medium 55 can be seen which is present here only between the two walls 62 and 53. The separating medium is fed in here again through the inlet 40 and the outlet 32 is used for example as an overflow protection.

In the situation shown in FIG. 6d, the sealing unit is disinfected in a dry state. It would be possible here to supply a gaseous sterilisation medium along the arrow P7 and to suck it off via through the inlet 40 and the outlet 32. As indicated by the arrows, the sterilisation medium flows here initially upwards along the arrow P7 and along the arrows P8 and P9 into the respective sterilisation medium channels and can in this way be sucked off through the inlet 40. Further, the sterilisation medium also flows to the outlet 32 and can also be sucked off there. This dry disinfection can be carried out here during the running operation and/or during production. The entire flow can, as an alternative to a gaseous sterilisation medium, also apply to air. This means that in particular during the running operation, sterile air can be sucked off through the inlet 40 from the clean room RR along the arrows P7 and P9, and environmental air can be sucked off from the grey room GR along the arrow P8 via the outlet 32.

Altogether, the individual surge tanks or cleaning units 20 that can be cleaned ensure a hygienic transfer, free of any re-contamination, of the required movements into the clean room, i.e. for transferring the lifting and rotating moments. The top part of the capping machine can here in some aspects also be used for so-called neck handling, i.e. the containers are transported through the machines by their neck ring.

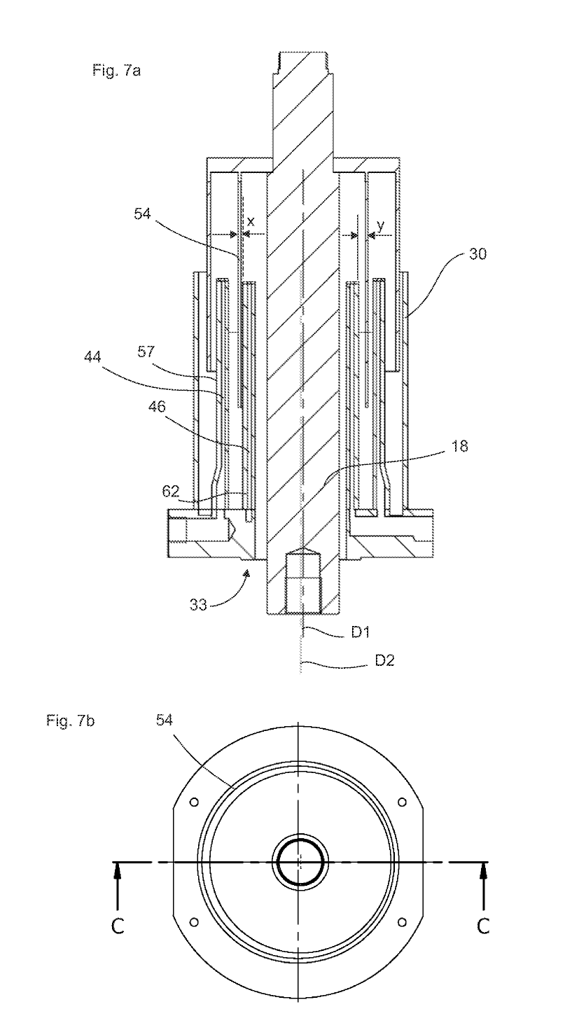

FIGS. 7a and 7b show a further embodiment which is here designed to be eccentric. The splashing behaviour of the individual sealing units 20 can be improved by displacing the stationary part, here the carrier 33, which means that a splashing of separating liquid 55 from the receptacle 34 and from the sealing unit 20, which may occur for example in the case of sudden changes of a rotary speed of the wall 22 about the axis T, may be avoided. The carrier 33 is here located on the wall 22. In this system, the rotary axis D1 of the capping head 8 runs along a pitch circle of the machine, however eccentrically to the central axes D2 of the individual containers or the housing 30 of the sealing units. This eccentricity is here represented by the two distances x and y, and it can be seen that the distance is greater on the right-hand side (y) than the distance (x) on the left-hand side.

In FIG. 7b, this eccentricity in relation to the separation wall 54 can also be seen.

As mentioned above, the sealing unit can also be used for dry aseptic processes by designing a cleaning channel as a suction channel.

It will be apparent to those skilled in the art that various modifications and variations can be made to the container treatment system of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. An apparatus for treating containers and for closing containers with closure caps, comprising:
a transport unit that transports the containers through a clean room, said clean room being separated by a plurality of walls against an environment; and
a plurality of treatment elements arranged within the clean room, each of said plurality of elements being movable in the direction of a predefined axis and rotatable in relation to the predefined axis in order to attach closure caps onto the containers, each of said treatment elements being arranged on a carrier that extends through a wall of the clean room, each of said treatment elements having associated therewith a sealing unit in order to seal at least one movement of the carrier, the sealing unit including a receptacle for receiving a liquid separating medium and a wall element movably arranged within the separating medium, at least one sealing unit having an inlet via which a cleaning medium can be supplied to the sealing unit.

2. The apparatus as claimed in claim 1, wherein the inlet is located below the receptacle.

3. The apparatus as claimed in claim 1, further comprising a first cleaning channel, which follows on from the inlet, for carrying the cleaning medium, said first cleaning channel extending in the direction of a longitudinal axis of the carrier at least in sections.

4. The apparatus as claimed in claim 3, wherein the first cleaning channel is arranged radially inside or radially outside of the receptacle.

5. The apparatus as claimed in claim 3, wherein the first cleaning channel has a substantially annular cross section.

6. The apparatus as claimed in claim 1, further comprising an outlet for the cleaning medium, which is located in the clean room.

7. The apparatus as claimed in claim 6, wherein the outlet is located above the receptacle.

8. The apparatus as claimed in claim 3, wherein a wall of the cleaning channel is formed through a wall of the receptacle.

9. The apparatus as claimed in claim 1, further comprising a housing arranged to be stationary, said housing completely surrounding the receptacle.

10. The apparatus as claimed in claim 1, further comprising an outlet for the cleaning medium.

11. The apparatus as claimed in claim 1, wherein a plurality of carriers is arranged on a movable main carrier.

12. An apparatus for treating containers, comprising:
a transport unit that transports the containers through a clean room, said clean room being separated by a plurality of walls against an environment;
a plurality of treatment elements arranged within the clean room, each of said plurality of elements being movable in the direction of a predefined axis and rotatable in relation to the predefined axis in order to attach closure caps onto the containers;
a carrier extending through one of said walls of the clean room, each of said treatment elements being arranged on the carrier; and
a sealing unit associated with each of said treatment elements, said sealing units being configured to seal at least one movement of the carrier, the sealing unit including
a receptacle for receiving a liquid separating medium, and
a wall element movably arranged within the separating medium,
at least one sealing unit having an inlet via which a cleaning medium can be supplied to the sealing unit.

13. The apparatus as claimed in claim 12, wherein the inlet is located below the receptacle.

14. The apparatus as claimed in claim 12, further comprising a first cleaning channel, which follows on from the inlet, for carrying the cleaning medium, said first cleaning channel extending in the direction of a longitudinal axis of the carrier at least in sections.

15. The apparatus as claimed in claim 14, wherein the first cleaning channel is arranged one of radially inside and radially outside of the receptacle.

16. The apparatus as claimed in claim 14, wherein the first cleaning channel has a substantially annular cross section.

17. The apparatus as claimed in claim 12, further comprising an outlet for the cleaning medium, the outlet being located in the clean room above the receptacle.

18. The apparatus as claimed in claim 14, wherein a wall of the cleaning channel is formed through a wall of the receptacle.

19. The apparatus as claimed in claim 12, further comprising a stationary housing that completely surrounds the receptacle.

20. The apparatus as claimed in claim 12, wherein a plurality of carriers is arranged on a movable main carrier.
